(19) United States
(12) Patent Application Publication
(10) Pub. No.: US 2016/0050848 A1
(43) Pub. Date: Feb. 25, 2016

(54) BALE SPREADER

(71) Applicant: Top Spread, LLC, Charles City, IA (US)

(72) Inventors: Bruce Goddard, Charles City, IA (US); Steve Smith, Charles City, IA (US)

(21) Appl. No.: 14/834,083

(22) Filed: Aug. 24, 2015

Related U.S. Application Data
(60) Provisional application No. 62/040,636, filed on Aug. 22, 2014.

(51) Int. Cl. A01D 90/10; A01F 29/00; B02C 13/286; B02C 18/06; B02C 13/02; B02C 13/20

(52) U.S. Cl. CPC A01D 90/10; B02C 13/02; B02C 13/20; B02C 13/286; B02C 18/06; A01F 29/005; B02C 2013/28636

(57) ABSTRACT

A spreader having at least two rotors rotatably attached to a first and a second support member. Extending below the rotors is a moveable apron. Attached above the support members is a hood with a pivotally connected deflector.

### CROSS REFERENCE TO RELATED APPLICATION

This application claims the benefit of U.S. Provisional Application No. 62/040,636 filed Aug. 22, 2014.

### BACKGROUND OF THE INVENTION

This invention is directed to a bale spreader and more particularly to a bale spreader having a plurality of rotors for chopping and spreading.

Bale spreaders are known in the art. Existing spreaders either do not chop the product, or they are limited in the amount of product that may be chopped and how fine the bale is chopped. Also, through the use of spinners, the distance product is spread is limited. Finally, after chopping, manual labor is required to clean out residual product. As a result, a need exists for a device that addresses these deficiencies.

Therefore, an objective of the present invention is to provide a bale spreader that chops more product and spreads the product further.

Another objective of the present invention is to provide a bale spreader where residual product is easy to clean out.

These and other objectives will be apparent to those skilled in the art based on the following written description.

### SUMMARY OF THE INVENTION

A bale spreader mounted to a loader having a bed with a moveable apron. A first and second rotor are rotatably connected to first and second support members and are driven by an auxiliary hydraulic system. The apron extends below the rotors.

A hood in connected to the top of the first and the second support members. Pivotally connected to the hood is a deflector.

### BRIEF DESCRIPTION OF THE DRAWINGS

FIG. 1 is an end perspective view of a bale spreader;

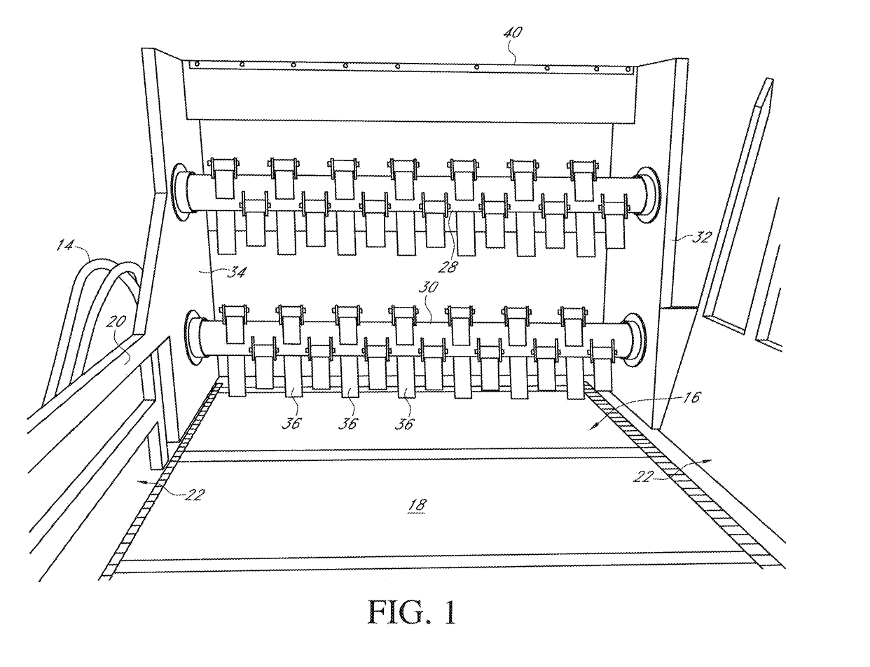

FIG. 2 is a perspective view of a bale spreader; and

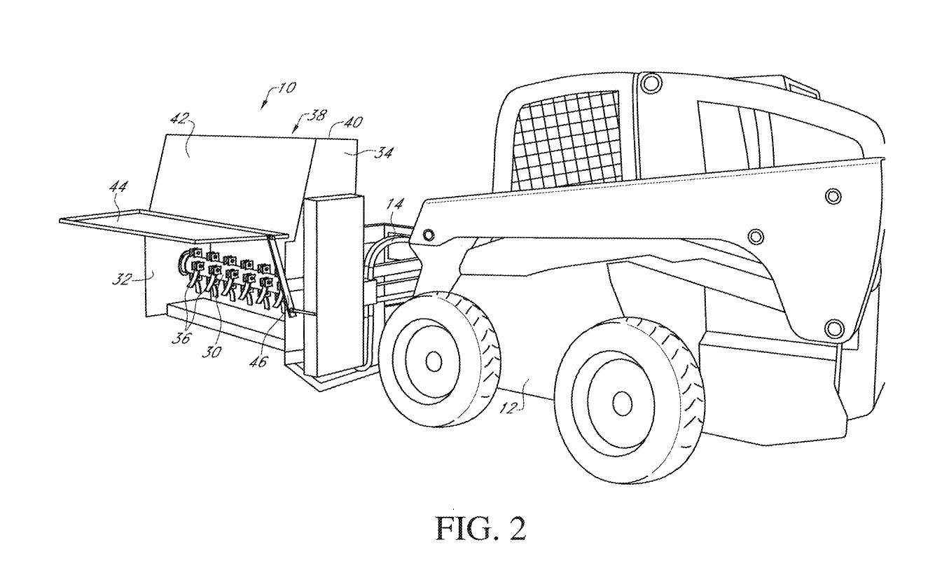

FIG. 3 is a side perspective view of a bale spreader.

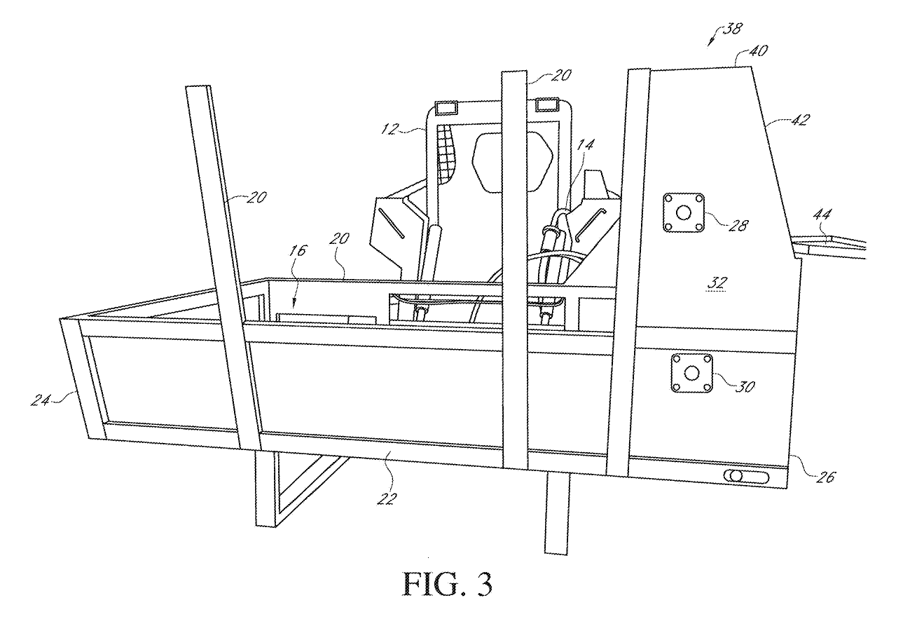

### DETAILED DESCRIPTION OF THE PREFERRED EMBODIMENTS

Referring to the Figures, the bale spreader 10 is mounted to a loader 12 having an auxiliary hydraulic system 14. The bale spreader 10 has a bed 16 with a moveable apron or conveyor 18 and support rails 20 on each side 22 and at first end 24.

At an opposite second end 26 a first 28 and second 30 rotor are rotatably mounted to support members 32 and 34. Additional rotors may be used if desired. The rotors 28 and 30 are connected to and driven by the auxiliary hydraulic system 14 of the loader. Preferably, the rotors 28 and 30 are positioned in vertical spaced with offset alignment with each having a plurality of flail hammers and, or knives 36. In alternative arrangements the rotors 28 and 30 are in vertical spaced alignment.

A hood 38 is connected to support members 32 and 34 and has a top wall 40, and a front wall 42 that covers a portion of the second end 26. Pivotally connected to the front wall 42 is a deflector 44 having a support arm 46 that is connected to and extends between the deflector 44 support member 34. Preferably the deflector is flexible.

In operation a bale 48 is placed in the bed 16 of the bale spreader 10. The auxiliary hydraulic system 14 Which is operatively connected to the apron 18 is activated causing the apron 18 to rotate moving the bale 48 toward the rotors 28 and 30. As the bale 48 engages the rotors 28 and 30 the flail hammers 36 chop the bale 48 and the rotational speed of the rotors 28 and projects the chopped bale 48 outwardly and away from the second end 26 of the bale spreader. The deflector 44 is selectively positioned using the support arm 46 to allow the chopped bale 48 to freely exit the second end 26 or to be deflected downwardly toward the ground so as not to cause damage to a building and the like. The apron 18 continues to rotate and extends under rotors 28 and 30 such that the remaining chopped bale is transported to the second end 26 to clean out the bed. In one embodiment, the apron 18 extends fully under the rotors 28.

Accordingly, a bale spreader 10 has been disclosed that due to a plurality of rotors chops more product and spreads the product further. Also, having the apron 18 under the rotors 28 allows for easy clean out of the bed.

What is claimed is:

1. A bale spreader, comprising;
a first and a second rotor notably connected to first and second support members; and
a bed having a moveable apron that extends under the rotors.

2. The spreader of claim 1 wherein the rotors are driven by an auxiliary hydraulic system.

3. The spreader of claim 1 wherein he first and the second rotors are positioned in vertical spaces offset alignment.

4. The spreader of claim 1 wherein the rotors have a plurality of flail hammers.

5. The spreader of claim 1 further comprising a hood connected to the first and second support members.

6. The spreader of claim 5 further comprising a deflector pivotally connected to the hood.

7. The spreader of claim 1 wherein the rotors have a plurality of flail knives.
